(19) United States
(12) Patent Application Publication
(10) Pub. No.: US 2020/0392882 A1
(43) Pub. Date: Dec. 17, 2020

(54) VALVE, EXHAUST BRANCH FOR AN INTERNAL COMBUSTION ENGINE AND VEHICLE HAVING AN INTERNAL COMBUSTION ENGINE

(71) Applicant: Faurecia Emissions Control Technologies, Germany GmbH, Augsburg (DE)

(72) Inventors: Francois FERNAND, Augsburg (DE); Bastien PERICHON, Augsburg (DE)

(21) Appl. No.: 16/898,512

(22) Filed: Jun. 11, 2020

(30) Foreign Application Priority Data
Jun. 13, 2019 (DE) 10 2019 116 156.8

(51) Int. Cl. F01N 3/02; F01N 13/08; F16K 11/052

(52) U.S. Cl. CPC F01N 3/0205; F16K 11/052; F01N 13/08

(57) ABSTRACT

A valve has a housing and a flap. The housing includes a chamber having an inlet, a first outlet, and a second outlet. The flap is rotatably mounted about an axis of rotation within the chamber and is movable between a first position in which the inlet is fluidically connected to the first outlet and the second outlet is closed, a second position, in which the inlet is fluidically connected to the second outlet and the first outlet is closed, and a third position in which the inlet is fluidically connected to the first outlet and the second outlet. The flap has a projection that projects into the second outlet in the first position of the flap. Furthermore, an exhaust branch for an internal combustion engine having a heat exchanger, a bypass, and the valve, and a vehicle having an internal combustion engine and the exhaust branch are provided.

### CROSS REFERENCE TO RELATED APPLICATIONS

This application is a U.S. non-provisional application claiming the benefit of German Application No. DE 10 2019 116 156.8, filed on Jun. 13, 2019, which is incorporated herein by its entirety.

### TECHNICAL FIELD

The disclosure relates to a valve having a housing and a flap. Furthermore, the disclosure relates to an exhaust branch for an internal combustion engine, having a heat exchanger, a bypass, and such a valve, and a vehicle having an internal combustion engine and such an exhaust branch.

### BACKGROUND

Valves for an exhaust branch of an internal combustion engine are known.

In order to comply with increasingly stringent CO₂ emission regulations and to improve fuel consumption, it is a goal, in particular in commercial vehicles, to use the hot exhaust gas of the internal combustion engine for energy recovery via heat recovery systems. These systems are usually equipped with a heat exchanger in which a working medium is vaporized to generate electricity. The working medium is sensitive to high temperatures under full load, so that an alternative exhaust gas path, also referred to as a bypass, is required to bypass the heat recovery system and direct the exhaust gases directly into the environment. Furthermore, the back pressure caused by the heat exchanger increases significantly under full load, which is why the bypass is additionally needed for reducing the back pressure.

In order to switch between the exhaust gas path through the heat exchanger and the bypass, a valve is required, which usually has a flap to close and open the exhaust gas paths. A further requirement for the valve is that the flap can be adjusted in stable intermediate positions in order to guide the exhaust gas of the internal combustion engine in different proportions through the different exhaust gas paths of the exhaust branch and thus prevent the maximum coolant temperature of the vehicle cooling circuit from being exceeded.

A well-known problem here is that the bypass usually opens directly into the environment, while the exhaust gas path leads through the heat exchanger for heat recovery and the latter generates a high back pressure. This imbalance in the back pressure between the two exhaust gas paths causes exhaust gas to be sucked in by the bypass, resulting in difficulties in controlling the flap and the mass flow of the exhaust gas.

### SUMMARY

A valve is provided which ensures a reliable distribution of the mass flow even if different back pressures are applied to the outlets of the valve.

A valve according to an exemplary aspect of the present disclosure includes, among other things, a housing and a flap. The housing has a chamber having an inlet, a first outlet leading to the heat exchanger, and a second outlet leading to the bypass. The flap is rotatably mounted about an axis of rotation in the chamber and is adjustable between a first position, in which the inlet is fluidically connected to the first outlet and the second outlet is closed, a second position, in which the inlet is fluidically connected to the second outlet and the first outlet is closed, and a third position with positional stability, in which the inlet is fluidically connected to the first outlet and to the second outlet. The flap has a fastening section through which the axis of rotation passes, and a cover closing the first outlet and the second outlet and having a first side and an oppositely arranged second side. The axis of rotation extends through the chamber between the first outlet and the second outlet and is located laterally of the cover. It is provided that in the first position, the second side of the cover covers the second outlet and in the second position, the first side of the cover covers the first outlet. Furthermore, the flap has a projection which extends on the second side directly away, i.e. immediately, from the cover and which projects into the second outlet in the first position of the flap.

This design of the valve causes the projection to block the second outlet in sections when the flap is moved out of the first position and the cover opens the second outlet. Thus, when the second outlet is opened, the projection reduces the cross-section through which exhaust gas can flow through the second outlet. In other words, instead of opening the second outlet to the bypass directly by lifting the cover and having the full cross-section of the second outlet available for flow, the function of the projection is to increase the available cross-section of the second outlet for the exhaust gas flowing into the bypass as the opening angle of the flap increases. In contrast to a flap without projection, in which the cross-section of the second outlet through which a flow can pass is constant in all at least partially opened flap positions, the cross-section of the second outlet through which a flow can pass changes with the opening of the flap in the flap having a projection, as the proportion of the cross-section of the second outlet through which the projection extends changes with the opening angle of the flap.

The cross-section of the second outlet corresponds in particular to the cross-sectional area of the opening formed by the second outlet and not to the area of the opening, which is formed between the flap and the second outlet when the flap is moved from the first position into a position in which the second outlet is open. In other words, the cross-section of the second outlet is determined by the cross-section of the valve seat, i.e. the area of the opening circumscribed by the annular contact or sealing surface. In the closed state of the second outlet, the flap rests on the annular contact or sealing surface. So far, as soon as the flap lifts off this annular contact or sealing surface, the entire flow cross-section of the second outlet is available. In the disclosure, however, the projection projects into this cross-sectional area and significantly reduces the latter.

Thus, the core of the disclosure consists in increasing the low back pressure of the bypass through the projection in the second outlet compared to the first outlet when the flap moves out of the first position and thus opens the second outlet. This reduces the pressure difference between the first and the second outlet and thus the suction effect at the second outlet, which impairs the accurate control of the flap.

In this way, the suction effect can be reduced via the projection, which improves the controllability of the valve and allows the mass flow to be divided between the two outlets in a reliable and precisely adjustable manner.

The cover can be configured to block the second outlet in sections when the flap is moved from the first position and the cover opens the second outlet, to effectively reduce the suction effect.

The valve is here a valve having at least three ports or ways that are formed by the inlet, the first outlet, and the second outlet, and/or are accordingly fluidically connected thereto.

According to one embodiment, the valve is a 3-way valve, in particular a T-shaped 3-way valve.

In the case of the T-shaped 3-way valve, one outlet can be arranged opposite the inlet, in particular at an angle of 180°, and the other outlet can be arranged laterally, in particular at an angle of 90° to the inlet.

Here, the housing or duct sections adjacent to the housing form a duct in the shape of a T.

In a further embodiment, the angle of the 3-way valve between the inlet and one of the outlets and between the two outlets can respectively be between 60° and 120°, i.e. the 3-way valve is not restricted to shapes having right-angled branches and can also have the shape of a Y, for example.

The valve is in particular intended for an exhaust branch of an internal combustion engine and is correspondingly configured to be heat-resistant.

It can be advantageous if the first side of the cover is configured to be flat. Therefore, no projection and/or protrusion projects from the first side of the cover, so that the flow resistance formed by the flap is minimized, in particular in the first position of the flap, in which the second side of the cover covers the second outlet and the first side of the cover is in particular completely exposed to the flow through the valve. Alternatively or in addition thereto, the second side of the cover, in this case with the exception of the projection, may also be configured to be flat. This simplifies the manufacture of the cover and also ensures that a flow resistance is generated purposefully only by the projection.

In one embodiment, the cover has a virtual central axis, which runs parallel to the axis of rotation and divides the cover into a proximal half, which is located between the central axis and the axis of rotation, and a distal half, which extends away from the central axis in the opposite direction to the proximal half. The projection is here at least in sections located in the distal half so that in the first position of the flap, the projection extends through that part of the cross-section of the second outlet, which is further away from the axis of rotation compared to another part of the cross-section. As the flow through the part of the cross-section of the second outlet which is further away from the axis of rotation is stronger at small opening angles of the flap relative to the first position than through the part of the cross-section of the second outlet which is located closer to the axis of rotation, the projection has a particularly positive influence on the control behavior of the flap and on the adjustment of the mass flow due to this design.

A further variant by which it is possible to reduce the suction effect consists in the that the cover has a virtual central axis which runs parallel to the axis of rotation and divides the cover into a proximal half, which is located between the virtual central axis and the axis of rotation, and a distal half, which extends away from the central axis in the opposite direction to the proximal half. The projection has an elongated front side, i.e. a surface that is turned towards the flow when the valve is opened and which begins on the second side of the cover. This elongated front side has a direction of extension parallel to the axis of rotation, i.e. it has an extension component that is parallel to the axis of rotation, or the front side runs completely parallel to the axis of rotation. The elongated front side therefore does not run in a surface that extends at right angles to the axis of rotation, and thus would not offer any resistance to the flow at the beginning of the opening process.

In a further embodiment, the projection, in particular the exterior side of the projection opposite the housing in the first position, is configured at least in sections to be complementary to the cross-section of the second outlet. This configuration has the advantage that the flow course is particularly favorable at small opening angles of the flap relative to the first position, so that the mass flows through the valve can be controlled particularly accurately.

Preferably, the section of the projection, which is located on the distal half is configured to be at least in sections complementary to the cross-section of the second outlet. The projection can thus effectively shield the second outlet.

The projection can be configured to have a C-shape. This configuration of the projection leads to a particularly favorable flow course, in particular with a second outlet having a round or circular cross-section.

Furthermore, the projection can be configured such that the C-shape is open towards the axis of rotation, the arc of the “C” extending away from the axis of rotation.

It may be provided that the height of the projection perpendicular to the cover is maximum at a point of the projection that is at the greatest distance from the axis of rotation. The effect of the projection on the flow behavior through the second outlet is therefore particularly favorable.

The height of the projection can decrease with decreasing distance from the axis of rotation, in particular steadily, as a result of which the effect of the projection decreases with increasing opening angle of the flap relative to the first position.

In a further embodiment, the projection extends over a width parallel to the axis of rotation, which corresponds to at least 30%, in particular at least 50%, of the maximum width of the cover as measured parallel to the axis of rotation of the cover. In this way, the projection effectively shields the second outlet and favors a particularly advantageous flow behavior.

According to the disclosure, an exhaust branch for an internal combustion engine having a heat exchanger, a bypass and a valve according to the disclosure is also provided. The valve is arranged to lead exhaust gas through the heat exchanger via the first outlet and to lead exhaust gas through the bypass past the heat exchanger via the second outlet, i.e. not through the heat exchanger. In this way, the mass flow of the exhaust gas can be reliably distributed between the exhaust gas path with the heat exchanger and the bypass, even if different back pressures are present at the first and the second outlet.

According to one embodiment, the valve is configured such that for an exhaust gas flow having a temperature of 400° C. and a mass flow of 1200 kg/h, with a flap stroke of at least 13°, preferably at least 15°, 60% to 100% of the volume flow is guided through the heat exchanger. This means that for the operating range of the valve, in which the majority of the volume flow of the exhaust gas is guided through the heat exchanger, an angular range of at least 13°, preferably at least 15°, of the flap is provided. Thus, in this operating range, a change of 1° in the flap stroke, i.e. the angular position of the flap, leads on average to a change in the volume flow of less than 3.1%, in particular of less than 2.7%, so that the volume flow or mass flow can be adjusted particularly finely and thus precisely.

According to a further exemplary embodiment, the valve is configured such that for an exhaust gas flow having a temperature of 400° C. and a mass flow of 1200 kg/h in a range in which 70% to 80%, in particular 65% to 80%, of the volume flow is guided through the heat exchanger, the proportion of the volume flow which is guided through the heat exchanger changes proportionally to the flap stroke. The proportional control behavior has the advantage that, in this operating range, the volume flow or mass flow can be divided particularly precisely and reliably between the exhaust gas path with the heat exchanger and the bypass.

According to the disclosure, a vehicle having an internal combustion engine and an exhaust branch according to the disclosure having the above-mentioned advantages is also provided.

### BRIEF DESCRIPTION OF THE DRAWINGS

FIG. 1 shows a schematic representation of a vehicle according to the disclosure having an exhaust branch according to the disclosure which comprises a valve according to the disclosure,

FIG. 2 shows a schematic representation of the valve of FIG. 1 having a first and a second outlet and a flap in a first, a second, and a third position,

FIG. 3 shows a perspective view of the flap of FIG. 2 according to a first variant,

FIG. 4 shows the flap of FIG. 3 in a top view,

FIG. 5 shows the flap of FIG. 3 in a front view,

FIGS. 6 to 8 show further variants of the flap of FIG. 2 in a top view,

FIG. 9 shows a further variant of the flap of FIG. 2 in a top view,

FIG. 10 shows the flap of FIG. 9 in a front view,

FIG. 11 shows a further variant of the flap of FIG. 2 in a top view,

FIG. 12 shows the flap of FIG. 11 in a front view, and

FIG. 13 shows a diagram showing the proportion of the volume flow guided through the first outlet versus the angle of the flap.

### DETAILED DESCRIPTION

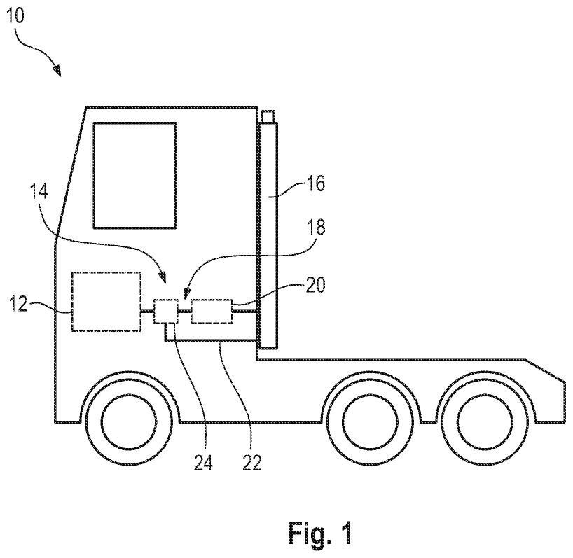

FIG. 1 shows a vehicle 10 having an internal combustion engine 12 intended to drive the vehicle 10, and an exhaust branch 14 that is coupled to the internal combustion engine 12, and via which exhaust gases of the internal combustion engine 12 are directed to an exhaust 16 of the vehicle 10.

The vehicle 10 is a truck.

In an alternative exemplary embodiment, the vehicle 10 can be any vehicle, in particular any commercial vehicle.

The exhaust branch 14 has an exhaust gas path 18 including a heat exchanger 20, a bypass 22, and a valve 24.

The heat exchanger 20 is part of a heat recovery system by which part of the thermal energy of the exhaust gas is converted into electrical energy and is thus available to the vehicle 10.

The valve 24 is a 3-way valve and, as explained later, is configured to direct exhaust gas of the internal combustion engine 12 through the exhaust gas path 18 and thus through the heat exchanger 20 in a first position, to direct exhaust gas of the internal combustion engine 12 through the bypass 22 and thus past the heat exchanger 20 in a second position, and to direct exhaust gas of the internal combustion engine 12 proportionally both through the exhaust gas path 18 and the bypass 22 in a third position.

In an alternative exemplary embodiment, the valve 24 can have more than three ports and be a 4-way or 5-way valve, for example.

The exhaust gas path 18 and the bypass 22 are each fluidically connected to the exhaust 16, through which the exhaust gas is released into the environment.

In principle, the valve 24 can be located anywhere and for any purpose as a valve in the vehicle 10. For example, the valve 24 can be provided to bypass an SCR monolith (SCR=selective catalytic reduction) or other elements in the exhaust branch 14 of the vehicle 10.

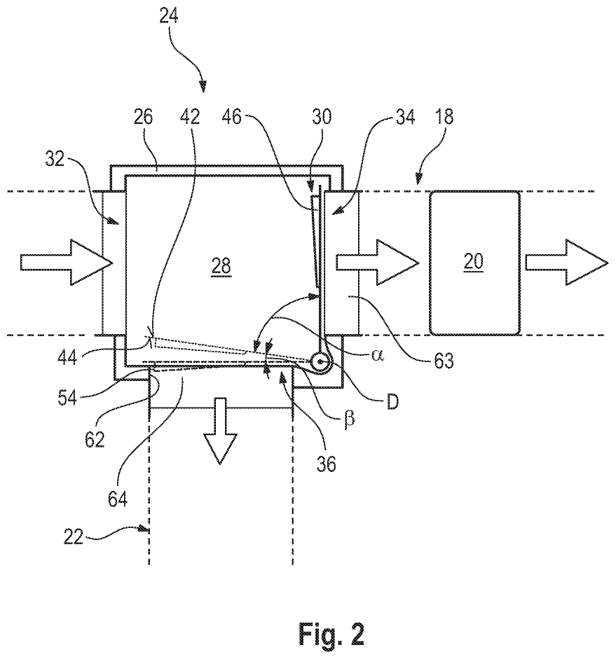

The valve 24 (see FIG. 2) has a housing 26, a chamber 28, a flap 30, an inlet 32, a first outlet 34, and a second outlet 36.

The chamber 28 is enclosed by the housing 26 and is fluidically connected to the internal combustion engine 12 via the inlet 32, to the exhaust gas path 18 via the first outlet 34, and to the bypass 22 via the second outlet 36.

The inlet 32, the first outlet 34, and the second outlet 36 each form a passage 63, 64 in the housing 26 having a circular cross-section.

In an alternative exemplary embodiment, the inlet 32, the first outlet 34, and the second outlet 36 can of course have any cross-section.

The inlet 32, the first outlet 34, and the second outlet 36 are each arranged on a separate side of the cuboid chamber 28, so that the valve 24 has a T-shape. The inlet 32 is located opposite the first outlet 34, while the second outlet 36 is located on the side of chamber 28 adjacent to both the inlet 32 and the first outlet 34.

In an alternative exemplary embodiment, the chamber 28 can have any shape. In addition or alternatively, the inlet 32, the first outlet 34, and the second outlet 36 may be provided on any sides of the chamber 28, the first outlet 34 and the second outlet 36 being however preferably located on sides of the chamber 28 adjacent to each other so that the flap 30 can close both the first outlet 34 and the second outlet 36 as described below.

The flap 30 is arranged in the chamber 28 and is mounted to the housing 26 to be adapted to pivot about an axis of rotation D.

The axis of rotation D is arranged adjacent to the first outlet 34 and adjacent to the second outlet 36 and thus extends between the first outlet 34 and the second outlet 36 through the chamber 28.

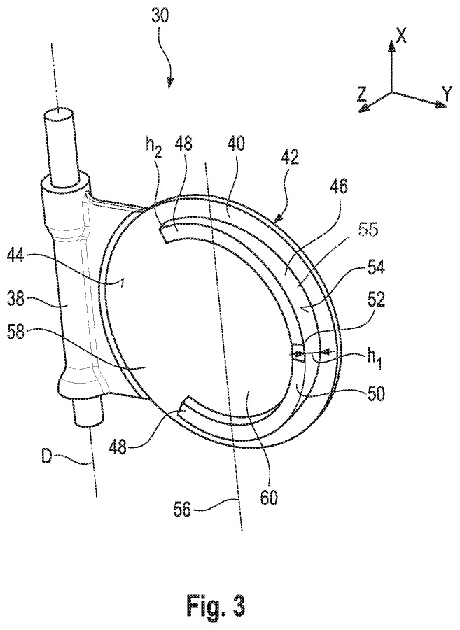

The flap 30 has a fastening section 38 (see FIG. 3) through which the axis of rotation D passes, and a cover 40 which is adjacent to and extends away from the fastening section 38.

The cover 40 is configured circular in shape and has a first side 42 and a second side 44 opposite the first side 42.

Basically, the cover 40 can have any shape. However, shapes corresponding to the cross-sections of the outlets 34, 36 are preferred to ensure efficient covering of the outlets 34, 36.

The first side 42 of the cover 40 is configured flat.

On the second side 44, the flap 30 has a projection 46 which is fastened to the cover 40 and which extends away from the cover 40 directly and perpendicularly to the second side 44.

With the exception of the projection 46, the second side 44 of the cover 40 is configured to be flat.

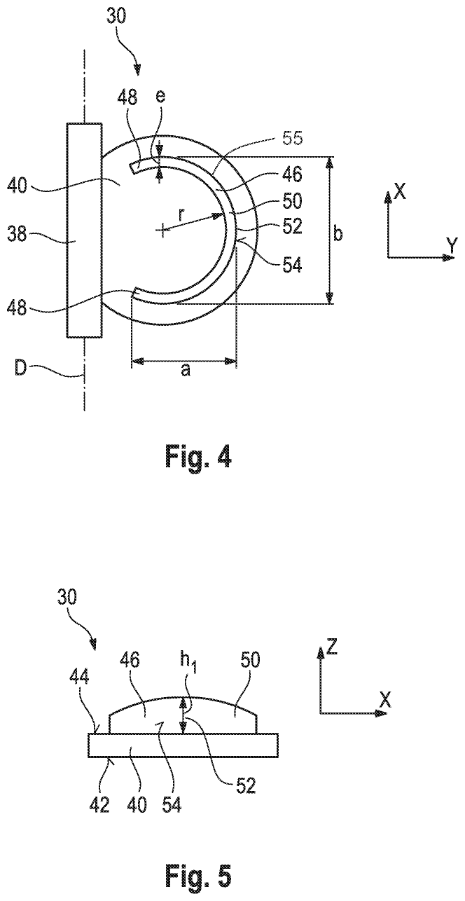

The projection 46 has a base (see FIG. 4) in the form of a circular ring section having an inner radius r, a thickness e, a length a perpendicular to the axis of rotation D, and a width b parallel to the axis of rotation D.

The projection 46 is thus configured so as to be C-shaped, the ends 48 of the C pointing towards the axis of rotation D and the arc 50 of the C extending away from the ends 48 and from the axis of rotation D. Thus, the C-shaped projection 46 is open towards the axis of rotation D.

The projection 46 extends in X direction over 80% of the width of the cover 40 in X direction. This means that the width b of the projection 46 parallel to the axis of rotation D corresponds to 80% of the maximum width of the cover 40 as measured parallel to the axis of rotation D. More generally, in order to effectively prevent or reduce the suction effect, the projection should run over a width b parallel to the axis of rotation D corresponding to at least 30%, and in particular at least 50%, of the maximum width of the cover 40 parallel to the axis of rotation D. This applies to all the exemplary embodiments shown.

At the point 52 furthest away from the axis of rotation D, the projection 46 has a height h₁ (see FIG. 5), which also forms the maximum height of the projection 46.

At each end 48, the projection 46 has a height h₂ which is less than the height h₁.

The height of the projection 46 decreases steadily and continuously from the point 52 to the ends 48.

The exterior side 54 of the projection 46, which, as explained later, is located in the second outlet 36 opposite the housing 26 in the first position of the flap 30, is configured to be complementary to the cross-section of the second outlet 36. This means that the exterior side 54 is configured complementary to the wall 62 of the projection 64, which is formed by the second outlet 36 in the housing 26.

The projection 46 is dimensioned such that it does not hinder the adjustment of the flap 30, in particular in that the projection 46 does not contact the housing 26 in any position of the flap 30.

The cover 40 is divided into a proximal half 58 and a distal half 60 by a virtual central axis 56 which is parallel to the axis of rotation D. The proximal half 58 is located closer to the axis of rotation D compared to the distal half 60 and extends between the axis of rotation D and the central axis 56. The distal half 60 is located further away from the axis of rotation D compared to the proximal half 58 and extends away from the central axis 56 and the axis of rotation D.

In the exemplary embodiment of the flap 30 shown in FIGS. 3 to 5, 80% of the projection 46 is located on the distal half 60.

In principle, the projection 46 can be arranged in any proportion on the distal half 60. However, at least sections, in particular at least 50% of the projection 46 is preferably arranged on the distal half 60.

The flap 30 can be an injection-molded part, in particular made of plastic, and is preferably configured in one piece.

In an alternative exemplary embodiment, the flap 30 can be of any configuration. In an alternative exemplary embodiment, the projection 46 can in particular be of any configuration.

In an alternative exemplary embodiment, the projection 46 can, for example, be perforated and/or have through holes, which in particular extend through the projection 46 parallel to the second side 44.

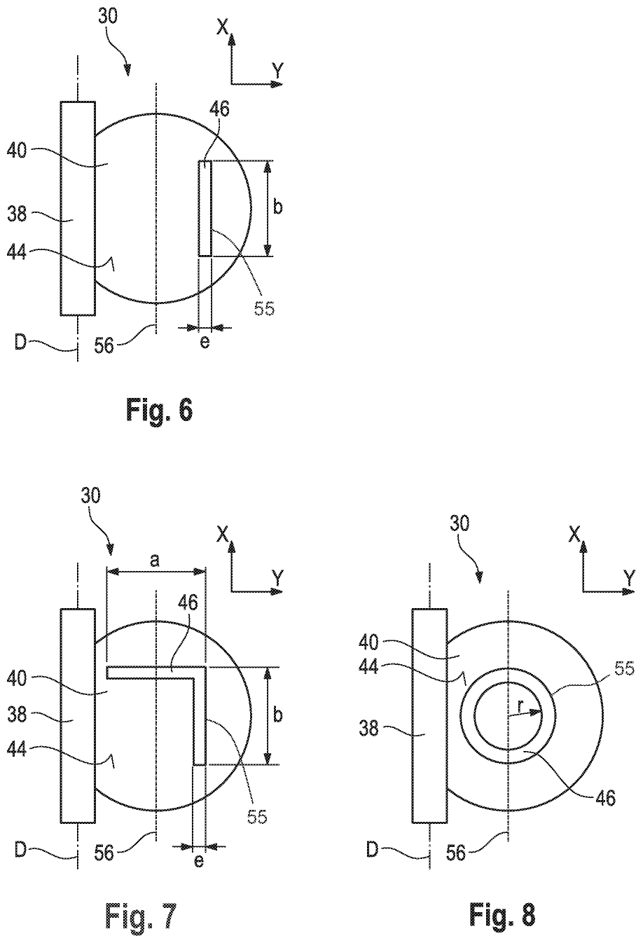

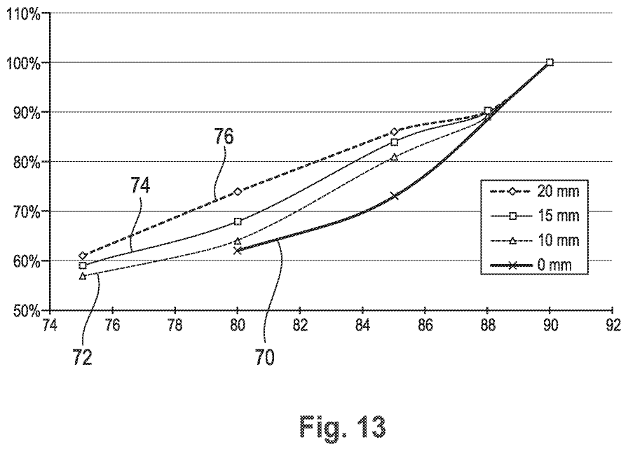

Variants of the flap 30 having alternatively configured projections 46 are now described with reference to FIGS. 6 to 13. For the components known from the above exemplary embodiment, the same reference numbers are used and in this respect, reference is made to the previous explanations.

In the variant of the flap 30 shown in FIG. 6, the projection 46 is configured as a linear structure extending parallel to the axis of rotation D having a width b and a thickness e.

In the variant of the flap 30 shown in FIG. 7, the projection 46 has an L-shaped base having a length a, a width b and a thickness e. The legs of the L are arranged perpendicular or parallel to the axis of rotation D.

In the variant of the flap 30 shown in FIG. 8, the projection 46 has a base in the form of a closed circular ring having an inner radius r, the center of which is located on the central axis 56. The projection 46 is configured to be concentric with the cover 40.

Each of the projections 46 of the variants of the flap 30 shown in FIGS. 6 to 8 has a height, in particular a constant height perpendicular to the second side 44 of the cover 40.

In addition, in each of the variants of the flap 30 shown in FIGS. 6 to 9, the projection 46 extends over half the width of the cover 40 in the X direction.

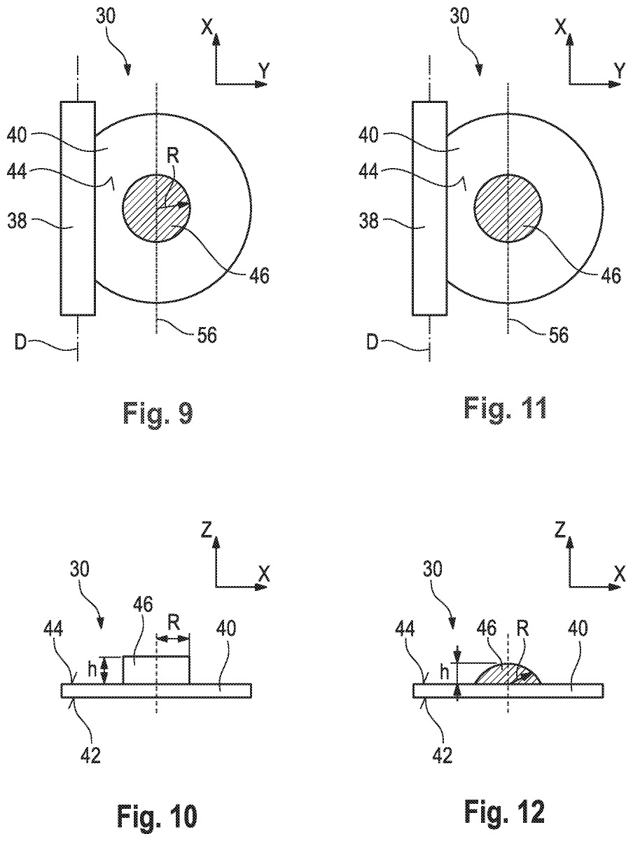

In the variant of the flap 30 shown in FIGS. 9 and 10, the projection 46 is configured as a circular cylinder which has an outer radius R and a height h and which is arranged concentric with the cover 40 on the central axis 56.

In the variant of the flap 30 shown in FIGS. 11 and 12, the projection 46 is configured in the form of a hemisphere which has a radius R and which is arranged concentric with the cover 40 on the central axis 56.

The outer radius R or the radius R of the projections 46 in the variants of the flap 30 shown in FIGS. 10 to 13 is one third of the width of the cover 40 in the X-direction.

Referring back to FIG. 2, the function of the flap 30 and of the valve 24 is explained below.

The flap 30 is adapted to pivot about the axis of rotation D between a first position (shown as a dashed line in FIG. 2) and a second position (shown as a solid line in FIG. 2). In addition, the flap 30 has a third position (shown as a dotted line in FIG. 2), which is an intermediate position between the first position and the second position of the flap 30.

The angle α which describes the angular position of the flap 30 relative to the second position is 90° in the first position and 0° in the second position, while the third position has an angle α between 0° and 90°.

In an alternative exemplary embodiment, in particular in which the sides of the chamber 28 with the outlets 34, 36 are not orthogonal to each other, the angles α may have correspondingly different values. For example, in an exemplary embodiment in which the sides of the chamber 28 with the outlets 34, 36 form an angle of 120°, the angle α is 120° in the first position, 0° in the second position and between 0° and 120° in the third position.

In the first position, the flap 30 completely closes the second outlet 36. The cover 40 then rests with its second side 44 on the section of the housing 26 surrounding the second outlet 36 and covers the second outlet 36 with its second side 44 at least in sections.

In the first position of the flap 30, the projection 46 is located opposite the chamber 28 on the cover 40 and extends into the second outlet 36.

Here, the exterior side 54 of the projection 46 is opposite a wall 62 of the housing 26, which is part of a passage 64 formed through the second outlet 36 in the housing 26.

In the first position, the inlet 32 is fluidically connected to the first outlet 34, but not to the second outlet 36.

In the second position, the flap 30 completely closes the first outlet 34. The cover 40 then rests with its first side 42 on the section of the housing 26 surrounding the first outlet 34 and covers the first outlet 34 with its first side 42 at least in sections.

In the second position of the flap 30, the projection 46 is located opposite the first outlet 34 on the cover 40 and extends into the chamber 28.

In the second position, the inlet 32 is fluidically connected to the second outlet 36 but not to the first outlet 34.

Both the first outlet 34 and the second outlet 36 may each be provided with a sealing element, such as a sealing lip, to ensure reliable sealing of the outlets 34, 36 by the flap 30.

In the third position, the flap 30 does not completely close the first outlet 34 and the second outlet 36, so that in this position, the inlet 32 is fluidically connected to both the first outlet 34 and the second outlet 36.

In the first position of the valve 24, in which the valve 24 directs exhaust gas (shown by arrows in FIG. 2) of the internal combustion engine 12 through the exhaust gas path 18, the flap 30 is in the first position. In the second position of the valve 24, in which the valve 24 directs exhaust gas of the internal combustion engine 12 through the bypass 22, the flap 30 is in the second position. In the third position of the valve 24, in which the valve 24 directs exhaust gas proportionally both through exhaust gas path 18 and the bypass 22, flap 30 is in the third position.

The valve 24 is coupled to a control unit of the vehicle 10 to transmit signals and can be controlled via an actuator.

For the exemplary embodiments according to FIGS. 2-9, the section of the exterior side 54 forming an obstacle to the incoming gas is elongated and is therefore a front side 55 starting from the second side 44 of the cover 40, which is directed to the flow when the valve is opened and runs in the distal half. This front side 55 has an extension component that runs parallel to the axis of rotation D. In the exemplary embodiment according to FIGS. 6 and 7, this front side 55 is completely parallel to the axis of rotation D. In the exemplary embodiments according to FIGS. 3, 4 and 8, the front side 55 is semicircular with a view perpendicular to the second side 44 of the cover 40. The elongated shape of the front side 55 is obtained in that the height of the projection 54 (measured perpendicular to the side 44) is less than the extension perpendicular thereto.

The effect of the projection 46 on the flow behavior of the exhaust gas of the internal combustion engine 12 through the valve 24 is explained below with reference to the diagram illustrated in FIG. 14, which shows the flow behavior for an exhaust gas flow having a temperature of 400° C. and a mass flow of 1200 kg/h as an example.

The angle α of the valve 30 in degrees is plotted on the abscissa. The proportion of the volume flow that flows through the first outlet 34 is plotted on the ordinate.

The diagram includes four curves 70, 72, 74, 76, which show the flow behavior with different flaps 30. The first curve 70 shows the flow behavior for a flap 30 without projection 46, i.e. for a flap 30 in which both the first and the second side 42, 44 of the cover 40 are configured to be flat. The second side 44 of the cover 40 is defined such that it does not include the projections 46 itself, even if the projections 46 start on the second side 44.

The curves 72, 74, 76 each show the flow behavior for a flap 30 having a projection 46 according to the exemplary embodiment shown in FIGS. 3 to 5. The second curve 72, the third curve 74 and the fourth curve 76 show the flow behavior for a flap 30 in which the projection 46 has a height h1 of 10 mm, 15 mm and 20 mm, respectively.

For an angle α of 90°, the flap 30 is in the first position and the second outlet 36 is completely closed. In this position of the valve 24, the entire exhaust gas flows through the first outlet 34 into the exhaust gas path 18 and thus through the heat exchanger 20.

As soon as the angle α is reduced and thus the flap 30 is moved out of the first position, a connection is established between the chamber 28 and the second outlet 36, as a result of which part of the volume flow flows through the second outlet 36 and thus through the bypass 22.

As the angle α decreases, i.e. as the opening angle β (see FIG. 2) between the flap 30 and the second outlet 36 increases, the proportion of the volume flow passing through the second outlet 36 increases and the proportion of the volume flow passing through the first outlet 34 decreases accordingly.

Due to the higher back pressure prevailing in the exhaust gas path 18 due to the heat exchanger 20 compared to the bypass 22, a suction effect is produced at the second outlet 36, so that for small opening angles β, a disproportionately large proportion of the volume flow flows through the second outlet 36 into the bypass 22.

Small opening angles β within this meaning are maximum angles of 20°, preferably 15°, in particular 10°.

This suction effect leads to a non-linear flow behavior, which is particularly pronounced in the case of a flap 30 without a projection 46, as can be seen from the first curve 70.

Due to the projection 46, a flow cannot immediately pass through the full cross-section of the second outlet 36 when the second outlet 36 is opened, as the projection 46 protrudes into the second outlet 36 at small opening angles β and thus blocks the cross-section thereof in sections. In this way, the flap 30 with the projection 46 increases the back pressure at the second outlet 36 or in the bypass 22 compared to a flap 30 without projection 46, thus reducing the suction effect.

In the case of a flap 30 having a projection 46 with a height h1 of 20 mm, this has the effect, as shown in the fourth curve 76, that the range in which between 100% and 60% of the volume flow passes through the first outlet 34 extends to positions of the flap 30 with angles α between 90° and less than 75°. This means that with a flap stroke of more than 15°, the range in which 60% to 100% of the volume flow is directed through the first outlet 34 can be adjusted.

In an alternative exemplary embodiment, the flap stroke in which 60% to 100% of the volume flow is directed through the first outlet 34 can be of any size and, for example, be at least 13°, as is the case in the third curve 74.

A further effect that the projection 46 with a height h1 of 20 mm has on the flow course is that in the range in which between 62% and 85% of the volume flow is directed through the first outlet 34, the proportion of the volume flow that is directed through the first outlet 34 changes proportionally with the flap stroke.

In an alternative exemplary embodiment, the range in which the proportion of the volume flow is guided through the first outlet 34 changes proportionally with the flap stroke can be of any size and preferably comprise a range in which 70% to 80%, in particular 65% to 80%, of the volume flow is guided through the first outlet 34, as is the case with the second and the third curve 72, 74.

The valve 24 is of course not limited to the exhaust flow of the example, i.e. thee valve 24 is provided for exhaust gas flows of any temperature and mass flow, wherein the effect of the projection 46 may vary in accordance with the exhaust gas flow.

Furthermore, the valve 24 is not limited to the use in exhaust branches 14, but can basically be used to control any fluid flows from any source.

In an alternative exemplary embodiment, the valve 24 can furthermore be provided to direct the fluid via the bypass 22 past any component which leads to a higher back pressure at the first outlet 34 than at the second outlet 36. This means in particular that the valve 24 can be provided in an exhaust branch 14 in which no heat exchanger 20 is present in the exhaust gas path 18.

In this way, a valve 24 is provided which reduces the suction effect when different back pressures are applied at the first and the second outlet 34, 36, and thus has an improved controllability.

By extending the range in which 60% to 100% of the volume flow is guided through the first outlet 34 to a large flap stroke, in particular of more than 13°, the mass flow can be divided between the two outlets 34, 36 in a precisely adjustable manner, even with small opening angles β.

In addition, the large proportional range at small opening angles β ensures a reliable distribution of the mass flow between the two outlets 34, 36.

This allows the proportion of exhaust gas guided through the heat exchanger 20 in an exhaust branch 14 to be reliably adjusted so that overheating of the heat exchanger 20 can be reliably prevented and the efficiency of the heat recovery system can be improved.

Further advantages result from the configurations described above, in particular the geometry of the valve 24 and of the flap 30.

The disclosure is not limited to the exemplary embodiment shown. In particular, individual features of one exemplary embodiment can be combined arbitrarily with features of other exemplary embodiments, in particular independently of the other features of the corresponding exemplary embodiments. Although various embodiments have been disclosed, a worker of ordinary skill in this art would recognize that certain modifications would come within the scope of this disclosure. For that reason, the following claims should be studied to determine the true scope and content of this disclosure.

1. A valve comprising:
a housing and a flap;
the housing including a chamber having an inlet, a first outlet, and a second outlet;
the flap being rotatably mounted about an axis of rotation in the chamber and being movable between a first position in which the inlet is fluidically connected to the first outlet and the second outlet is closed, a second position, in which the inlet is fluidically connected to the second outlet and the first outlet is closed, and a third position in which the inlet is fluidically connected to the first outlet and the second outlet;
the flap having a fastening section through which the axis of rotation passes, and a cover closing the first outlet and the second outlet and having a first side and a second side arranged opposite thereto;
the axis of rotation extending through the chamber between the first outlet and the second outlet and being arranged laterally of the cover;
the second side of the cover covering the second outlet in the first position and the first side of the cover covering the first outlet in the second position; and
the flap having a projection which extends on the second side away directly from the cover and which in the first position of the flap projects into the second outlet.

2. The valve according to claim 1, wherein the projection is configured to block the second outlet in sections when the flap is moved out of the first position and the cover opens the second outlet.

3. The valve according to claim 1, wherein the first side of the cover and/or the second side of the cover, with the exception of the projection, is or are configured to be flat.

4. The valve according to claim 1, wherein the cover has a virtual central axis which runs parallel to the axis of rotation and divides the cover into a proximal half, which is arranged between the virtual central axis and the axis of rotation, and a distal half, which extends away from the virtual central axis in an opposite direction to the proximal half, the projection being arranged at least in sections in the distal half.

5. The valve according to claim 1, wherein the cover has a virtual central axis which runs parallel to the axis of rotation and divides the cover into a proximal half, which is arranged between the virtual central axis and the axis of rotation, and a distal half, which extends away from the virtual central axis in an opposite direction to the proximal half, the projection having an elongated front side which is turned towards a flow when the valve is opened and begins on the second side of the cover and extends in the distal half and has a direction of extension parallel to the axis of rotation.

6. The valve according to claim 4, wherein the projection is configured to be complementary, at least in sections, to a cross-section of the second outlet, preferably the section of the projection which is arranged on the distal half.

7. The valve according to claim 6, wherein an exterior side of the projection opposite the housing in the first position, is configured to be complementary, at least in sections, to the cross-section of the second outlet, preferably the section of the projection which is arranged on the distal half.

8. The valve according to claim 6, wherein the section of the projection which is arranged on the distal half is configured to be complementary, at least in sections, to the cross-section of the second outlet.

9. The valve according to claim 1, wherein the projection is configured in a C shape.

10. The valve according to claim 9, wherein the projection is configured such that the C shape is open towards the axis of rotation.

11. The valve according to claim 1, wherein a height of the projection perpendicular to the cover is maximum at a point of the projection which is at a greatest distance from the axis of rotation.

12. The valve according to claim 11, wherein the height of the projection decreases with decreasing distance from the axis of rotation.

13. The valve according to claim 12, wherein the height of the projection continuously decreases with decreasing distance from the axis of rotation.

14. The valve according to claim 1, wherein the projection extends over a width parallel to the axis of rotation which corresponds to at least 30% of a maximum width of the cover as measured parallel to the axis of rotation.

15. An exhaust branch for an internal combustion engine comprising:
a heat exchanger, a bypass, and a valve;
the valve comprising a housing and a flap;
the housing including a chamber having an inlet, a first outlet and a second outlet;
the flap being rotatably mounted about an axis of rotation in the chamber and being movable between a first position in which the inlet is fluidically connected to the first outlet and the second outlet is closed, a second position, in which the inlet is fluidically connected to the second outlet and the first outlet is closed, and a third position in which the inlet is fluidically connected to the first outlet and the second outlet;
the flap having a fastening section through which the axis of rotation passes, and a cover closing the first outlet and the second outlet and having a first side and a second side arranged opposite thereto;
the axis of rotation extending through the chamber between the first outlet and the second outlet and being arranged laterally of the cover;
the second side of the cover covering the second outlet in the first position and the first side of the cover covering the first outlet in the second position;
the flap having a projection which extends on the second side away directly from the cover and which in the first position of the flap projects into the second outlet, and
the valve being arranged to conduct exhaust gas through the heat exchanger via the first outlet and to conduct exhaust gas through the bypass past the heat exchanger via the second outlet.

16. The exhaust branch according to claim 15, wherein the valve is configured such that for an exhaust gas flow having a temperature of 400° C. and a mass flow of 1200 kg/h, with a flap stroke of at least 13°, 60% to 100% of a volume flow is guided through the heat exchanger.

17. The exhaust branch according to claim 15, wherein the valve is configured such that for an exhaust gas flow having a temperature of 400° C. and a mass flow of 1200 kg/h, with a flap stroke of at least 15°, 60% to 100% of a volume flow is guided through the heat exchanger.

18. The exhaust branch according to claim 15, wherein the valve is configured such that for an exhaust gas flow having a temperature of 400° C. and a mass flow of 1200 kg/h, in a range in which 70% to 80% of a volume flow is guided through the heat exchanger, a proportion of the volume flow which is guided through the heat exchanger changes proportionally to a flap stroke.

19. The exhaust branch according to claim 18, wherein the valve is configured such that for an exhaust gas flow having a temperature of 400° C. and a mass flow of 1200 kg/h, in a range in which 65% to 80% of the volume flow is guided through the heat exchanger, the proportion of the volume flow which is guided through the heat exchanger changes proportionally to the flap stroke.

20. A vehicle including an internal combustion engine and an exhaust branch according to claim 15.
